(19) United States
(12) Patent Application Publication
(10) Pub. No.: US 2024/0119346 A1
(43) Pub. Date: Apr. 11, 2024

(54) SYSTEMS AND METHODS FOR AUTOMATED COMPROMISE PREDICTION

(71) Applicant: THE TORONTO-DOMINION BANK, TORONTO (CA)

(72) Inventors: CHENG CHANG, TORONTO (CA); HIMANSHU RAI, TORONTO (CA); YIFAN WANG, TORONTO (CA); MOHSEN RAZA, TORONTO (CA); GABRIEL KABO TSANG, MARKHAM (CA); MAKSIMS VOLKOVS, TORONTO (CA)

(21) Appl. No.: 17/962,321

(22) Filed: Oct. 7, 2022

(51) Int. Cl. G06N 20/00

(52) U.S. Cl. CPC G06N 20/00

(57) ABSTRACT

There is provided a computer implemented method, system and device for automatically generating a machine learning model for forecasting a likelihood of compromise in one or more transaction devices and subsequently triggering performing an action on one or more related computing devices based on a potentially compromised transaction device.

### FIELD

The present disclosure relates to systems and methods for automated compromise prediction, and more particularly to using computer systems and methods for automatically predicting the risk of account compromise using machine learning.

### BACKGROUND

Fraud is one of the leading problems plaguing modern banks, and fraud prevention is a constantly evolving area. Current approaches to fraud prevention focus on identifying fraudulent transactions following the receipt of a fraudulent transaction that has already occurred. However, existing methods are unable to identify compromised devices or associated accounts prior to fraudulent transaction requests being received by an entity. Notably, existing methods lack the ability to identify compromised devices (e.g. such as a compromised credit card) proactively, in real-time and prior to fraudulent transaction requests occurring.

Current computer and fraud-prevention technology employed at institutions lacks the capacity and functionality to independently, accurately and proactively identify the presence of fraudulent transactions contained within their user data. Current techniques require the manual input and guidance of fraud prevention teams at numerous points for flagging issues and in order to proceed to its next steps, creating a time-delay in the technology completing its tasks and introducing manual inaccuracies. Another limitation of the present methods is that is can only identify a fraudulent transaction once it has occurred, and are unable to proactively prevent or detect the fraudulent transactions from occurring.

Due to these limitations, the existing solutions are inefficient, unable to predict future issues, prone to error, rely on obsolete information and does not securely protect user data and computing systems, allowing for the build-up of fraudulent transaction requests in the institution's computerised systems and user accounts. They are also time-consuming due to their reliance on manual interventions, inefficient, prone to error, and rely on outdated data which may also provide indications of fraud that are obsolete or too late.

Resultant errors may result in fraudulent transactions being processed, causing security challenges and disruption of affected accounts and their data (e.g. depletion of accounts) and the expenditure of additional technological and computerised processing resources to deal with these inefficiencies and inaccuracies.

### SUMMARY

Compromised transaction devices including credit cards can result in large losses and security breaches for an institution. In at least some implementations, the present disclosure utilizes identified transaction trends and features based on historical data applied to generating an improved machine learning model to detect risk of compromise in a future time period, e.g. to prevent such security compromises.

Thus, there is a need to improve the functionality of computers and other fraud-prevention technologies and processes to automatically, dynamically, and proactively predict compromise in financial transaction device(s) (e.g. such as compromised credit cards, electronic wallets, wireless devices or other computing devices). Such proactive prediction and flagging of compromised devices, data, and accounts is facilitated by applying customized machine learning computing systems, methods and devices as described herein to allow a point (or points) of compromise model in a networked system of devices. Such proactive prediction occurs prior to the actual occurrence of computing device compromise or fraud. In some aspects, this includes compromise of a data source or data transaction (e.g. a comprised digital account and associated transaction data), and determining the risk of fraudulent transaction requests being received from an account or transaction device in the near-term future to proactively address compromised accounts prior to fraudulent transactions being processed.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer system for automatically generating a machine learning model for forecasting a likelihood of compromise in one or more transaction devices. The computer system also includes a processor configured to execute a specific set of instructions; a non-transient computer-readable medium may include instructions that when executed by the processor cause the processor to: retrieve from at least one database, an input of transaction data for a past time period for a plurality of transaction devices; split the transaction data for a first time period into training samples and validation samples for generating the machine learning model, the training samples being in-sample data and the validation samples being out-of sample holdout data, the splitting defined based on a predefined split determined from prior iterations of the model and allocated per transaction device; assign the transaction data in a second out-of time period outside the first time period to testing samples for the machine learning model for testing of the model; extract features from the training samples and the validation samples based on prior runs of the machine learning model indicating a correlation between the features being extracted and a degree of potential device compromise for a particular transaction device and associated transaction data; train the machine learning model using a gradient boosted algorithm applying the extracted features from the training samples and validating based on the validation samples from the first time period for in-time validation, the machine learning model once trained being further tested on the testing samples for out-of time testing of the model; and, generate, subsequent to the training and testing, the machine learning model configured to forecast a likelihood of compromise for each transaction device in the plurality of devices by applying associated new transaction data and extracting features therefrom based on the prior runs of the model for the likelihood. Other embodiments of this aspect include corresponding computer systems, apparatus, and computer programs recorded on one or more computer storage devices, each configured to perform the actions of the methods.

Implementations may include one or more of the following features. The system where the machine learning model is generated with at least one training sample set and two validation sample sets, one validation set relating to out of time validation and another validation set relating to out of sample validation. The second out-of time period occurs after the first time period being in-time and separated by a buffer window, the buffer window separating a window of time for feature extraction and a target window for testing the machine learning model. The machine learning model is an extreme gradient boosted model. The system is further configured to instruct one or more computing devices associated with the compromised transaction device to perform one or more actions based upon the likelihood of compromise detected for each transaction device. The window of time for feature extraction varies depending upon a type of feature being extracted thereby different features having associated different window sizes for the model to perform feature extraction. During the first time period, feature extraction and target evaluation are respectively associated with the training samples and the testing samples and performed in a sliding window format having a defined time period. The system being further configured to remove from consideration in training subsequent iterations of the machine learning model, transactions being associated with susceptible compromised transaction devices determined from prior runs of the machine learning model indicating a positive likelihood of compromise. The extracted features are selected from: enterprise data features, and fraud analytics features for the plurality of transaction devices, the enterprise data features having transaction device information and associated records for each transaction device; and the fraud analytics features selected from: transaction features, transaction device characteristics, recency features and merchant device features. Implementations of the described techniques may include hardware, a method or process, or computer software on a computer-accessible medium.

One general aspect includes a computer implemented method for automatically generating a machine learning model for forecasting a likelihood of compromise in one or more transaction devices. The computer implemented method also includes retrieving from at least one database, an input of transaction data for a past time period for a plurality of transaction devices; splitting the transaction data for a first time period into training samples and validation samples for generating the machine learning model, the training samples being in-sample data and the validation samples being out-of sample holdout data, the splitting defined based on a predefined split determined from prior iterations of the model and allocated per transaction device; assigning the transaction data in a second out-of time period outside the first time period to testing samples for the machine learning model for testing of the model; extracting features from the training samples and the validation samples based on prior runs of the machine learning model indicating a correlation between the features being extracted and a degree of potential device compromise for a particular transaction device and associated transaction data; training the machine learning model using a gradient boosted algorithm applying the extracted features from the training samples and validating based on the validation samples from the first time period for in-time validation, the machine learning model once trained being further tested on the testing samples for out-of time testing of the model; and, generating, subsequent to the training and testing, the machine learning model configured to forecast a likelihood of compromise for each transaction device in the plurality of devices by applying associated new transaction data and extracting features therefrom based on the prior runs of the model for the likelihood. Other embodiments of this aspect include corresponding computer systems, apparatus, and computer programs recorded on one or more computer storage devices, each configured to perform the actions of the methods.

One general aspect includes a computer system for automatically predicting a likelihood of transaction device compromise. The computer system also includes a processor configured to execute instructions; a non-transient computer-readable medium may include instructions that when executed by the processor cause the processor to: receive, at a machine learning model, a first input of historical transaction data relating to prior transaction information processed by the computer system, the historical transaction data including both compromised transaction devices and secured transaction devices, the machine learning model having been trained using the historical transaction data and the historical transaction data including a set of features defining the historical transaction data; receive, at the machine learning model, a second input of active transaction data, defined using a same set of features as the first input; in response to applying the inputs to the machine learning model, the machine learning model is configured to: determine a risk score for transactions associated with active transaction data; and predict transaction compromise for an associated transaction device based on the determined risk score. Other embodiments of this aspect include corresponding computer systems, apparatus, and computer programs recorded on one or more computer storage devices, each configured to perform the actions of the methods.

One general aspect includes a computer implemented method for automatically predicting transaction device compromise. The computer implemented method also includes receiving, at a machine learning model, a first input of historical transaction data relating to prior transaction information processed by the computer system, the historical transaction data including both compromised transactions and secured transactions, the machine learning model having been trained using the historical transaction data and the historical transaction data including a set of features defining the historical transaction data; Other embodiments of this aspect include corresponding computer systems, apparatus, and computer programs recorded on one or more computer storage devices, each configured to perform the actions of the methods.

In one aspect, there is provided a computer system for automatically predicting a likelihood of transaction device compromise, the computer system comprising: a processor configured to execute instructions; a non-transient computer-readable medium comprising instructions that when executed by the processor cause the processor to: receive, at a machine learning model, a first input of historical transaction data relating to prior transaction information processed by the computer system, the historical transaction data including both compromised transaction devices and secured transaction devices, the machine learning model having been trained using the historical transaction data and the historical transaction data including a set of features defining the historical transaction data; receive, at the machine learning model, a second input of active transaction data, defined using a same set of features as the first input; in response to applying the inputs to the machine learning model, the machine learning model is configured to: determine a risk score for transactions associated with active transaction data; and predict transaction compromise for an associated transaction device based on the determined risk score.

In one aspect, there is provided a computer implemented method for automatically predicting transaction device compromise, the method comprising: receiving, at a machine learning model, a first input of historical transaction data relating to prior transaction information processed by a computer system, the historical transaction data including both compromised transactions and secured transactions, the machine learning model having been trained using the historical transaction data and the historical transaction data including a set of features defining the historical transaction data; receiving, at the machine learning model, a second input of active transaction data, defined using a same set of features as the first input; in response to applying the inputs to the machine learning model, the machine learning model is configured to: determine a risk score for transactions associated with active transaction data; and predict transaction compromise for an associated transaction device based on the determined risk score.

### BRIEF DESCRIPTION OF THE DRAWINGS

These and other features of the invention will become more apparent from the following description in which reference is made to the appended drawings wherein:

FIG. 1A shows an example schematic block diagram of a prediction engine, according to one embodiment;

FIG. 1B shows a further detailed schematic of the example prediction engine of FIG. 1A and example communications with computing devices (e.g. across a communications network) for generating the compromise prediction, according to one embodiment;

FIG. 2 illustrates an example computing device for implementing the prediction engine of FIGS. 1A and 1B, according to one embodiment;

FIG. 3 illustrates an example of splitting up available in-sample and out of sample data for generating (e.g. training, testing and validation) of the machine learning model for performing comprise prediction and likelihood of risk calculation as provided in FIGS. 1A, 1B and 2, according to one embodiment;

FIG. 4 illustrates a schematic of an example timeline of sample data and the split of assigning the data for training and validating the machine learning model of FIGS. 1A, 1B and 2, according to one embodiment;

FIG. 5 illustrates a schematic of another example timeline of sample data including transaction related data and the selection of the data for generating the prediction model as shown in FIGS. 1A, 1B and 2, including training, feature selection, validation, and testing of the model, according to one embodiment; and

FIG. 6 illustrates an example flow of operations for the computing device of FIG. 2 implementing the prediction engine of FIGS. 1A and 1B, according to one embodiment.

### DETAILED DESCRIPTION

Generally, in at least some embodiments there is provided computing systems and methods utilizing machine learning to generate a machine learning model that is configured to capture transaction related data and associated metadata (e.g. from user accounts stored on computing devices and communications between transaction computing devices including transaction behaviours and user account behaviours), conduct a compromise risk assessment (e.g. indicative of compromise risk of a particular financial transaction device), provide a risk score associated with a risk of account compromise for the device, and proactively predict compromise for the financial transaction device based on the risk score (e.g. electronic wallet, digital credit card, wireless computing device storing accounts, etc.).

In at least some aspects, the computing systems and methods utilize the dynamically predicted compromise for the financial transaction device (e.g. associated with a financial transaction account on the device) to further determine and apply proactive computer-implemented technical solutions to prevent fraudulent transactions between computing devices (e.g. a source and a destination device) associated with a predicted compromised financial transaction device (e.g. and associated account(s)) prior to transaction depletion from the predicted compromised transaction device(s), and if applicable, any associated accounts.

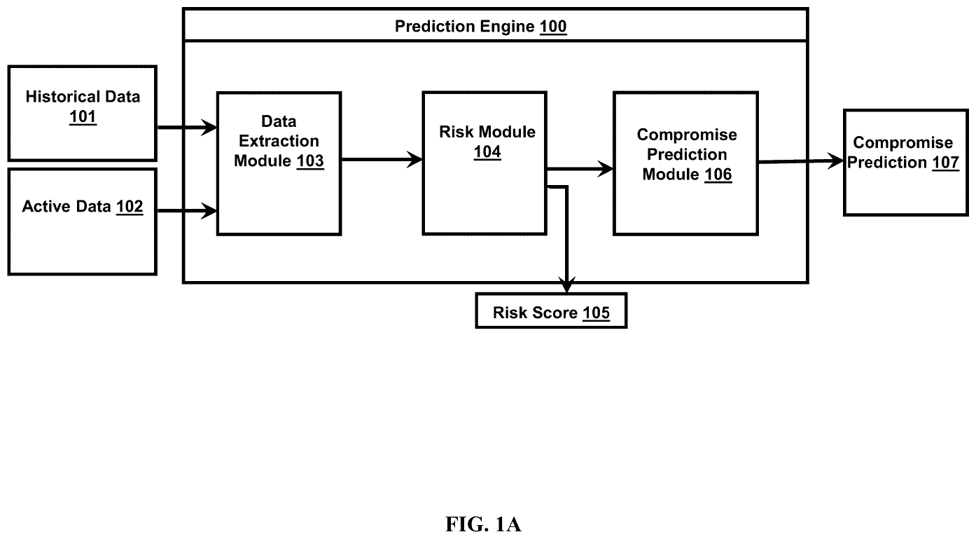

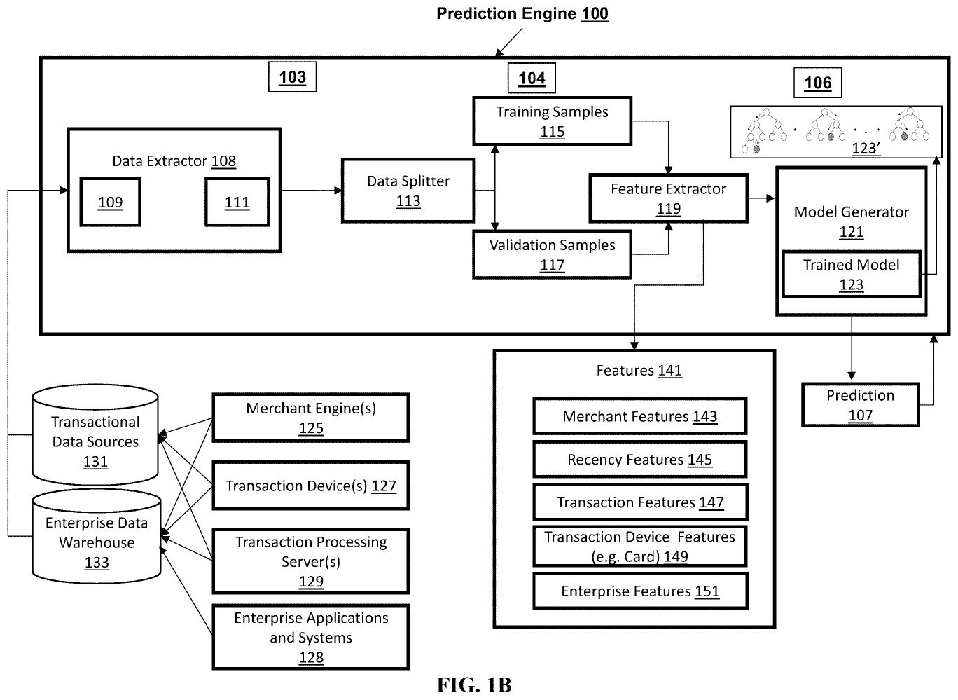

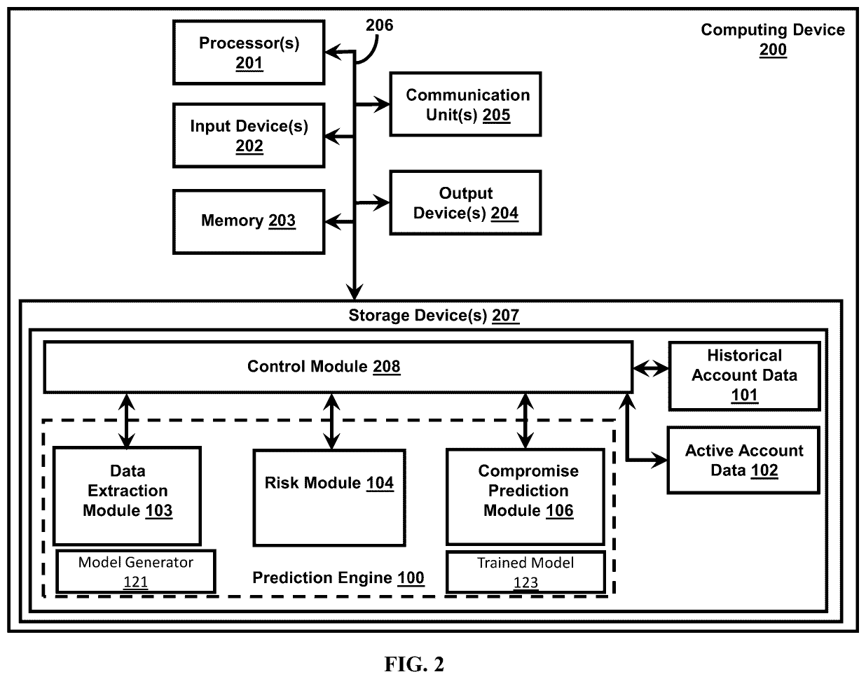

In some embodiments, a number of networked computing systems for initiating, performing and/or processing transactions (e.g. associated with one or more entities) may experience computing security risks, data breaches and/or fraud loss, as a result of one or more compromised financial transaction devices (e.g. compromised electronic cards) in the networked system. Automatic identification and pre-emptive proactive detection of likely risky or at risk financial transaction computing device(s) (e.g. list of electronic compromised cards having a higher than desired degree of risk) based on identified trends (e.g. transaction trends between the computing devices in the system indicative of potential fraud) is necessary to avoid and/or limit significant data and security breaches to the compromised device and/or connected computing devices associated with the compromised device in a networked system for the entity. In at least some implementations, by applying machine learning algorithms to the identified trends and transactions (e.g. communicated between the networked computing systems), a risk score may be assigned to each financial transaction device to depict a potential risk of the card being compromised and potential fraud in a future time period (e.g. immediate future) so that the computing systems and method as described herein may be implemented to target different levels of risk with different actions (e.g. for the associated computing devices). In some implementations, a high detected risk score may be utilized by the compromise model computing system (e.g. as shown in FIGS. 1A, 1B and 2) for proactive deactivation of the likely compromised financial transaction device and requiring reissuance thereof. In another aspect, a medium risk score may be applied by the compromise model computing system to configure the fraud rules stored thereon to have a lower tolerance for flagging (e.g. for upcoming events on the device indicative of potential fraud). In another aspect, low risk score may be associated on the compromise model computing system with an action marking the transactions as “normal” or “business as usual” alerts.

In yet further embodiments, the compromise model computing system may be configured to use the determined risk score to output and recommend one or more actions for associated computing system(s) to implement, such as displaying specific customized information relating to the risk (e.g. risk score 105 and/or account compromise prediction 107) to respective computing devices (e.g. output device(s) 204) for interaction with a fraud agent via a user interface.

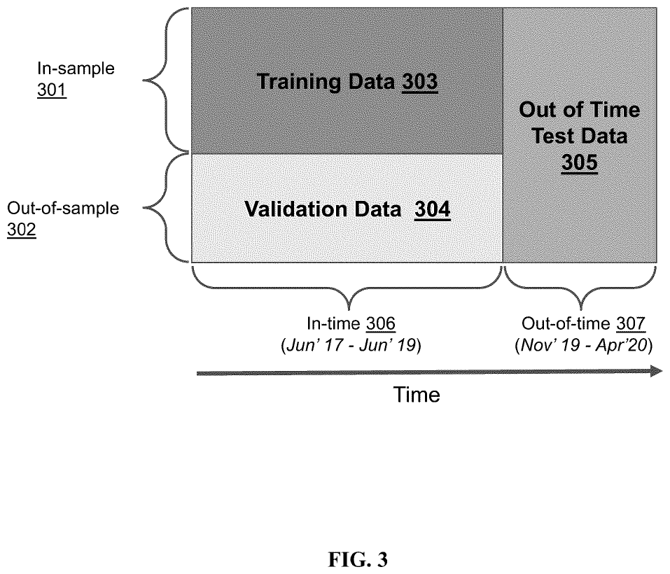

Generally and in at least some embodiments, the disclosed methods and systems relate to a machine learning model that is trained, tested and validated in a particular way as disclosed herein such as to allow effective and proactive compromise predictions of the transaction devices (e.g. by splitting and assigning available transaction data including in-sample, out-of-sample data, in-time and out of time data to training, testing and validation of the generated model as further shown in FIGS. 3-5).

Additionally, in at least some embodiments, there is disclosed methods and systems for feature engineering of the features based on the transfer and transaction data detected and communicated between transactional devices for which a likelihood of potential compromise is being tracked. For example, this may include the prediction engine detecting that transactions distribute differently based on a method of payment and thus automatically determining to aggregate features from different transactional/device channels, e.g. magnetic stripe, chip, online transactions etc.

Referring to FIG. 1A shown is an example prediction engine 100 utilizing machine learning model(s) and techniques particularly configured, according to one embodiment to perform compromise prediction of one or more transaction devices (e.g. digital wallets, digital transaction cards, RFID, token, digital chip, wireless devices etc.). The prediction engine 100 comprises: a data extraction module 103, a risk module 104, and compromise prediction module 106. In one embodiment, the prediction engine 100 is configured for using one or more training datasets (e.g. historical data 101 and/or active data 102) to build prediction modules (e.g. risk module 104, compromise prediction module 106) utilizing supervised machine-learning to predict transaction device compromise, based on assessing transaction data on each device and/or associated accounts being considered for potential compromise within an entity and properties (e.g. active account data 102). In at least some aspects, the transaction devices for which compromise is examined and/or detected includes but not limited to: digital wallets, credit cards, debit cards, wireless devices, RFID, tokens, electronic payment systems, computing devices capable of performing transactions, or other computing devices including payment instruments, etc.

Conveniently, in at least some aspects, the disclosed systems and methods are configured to proactively detect and identify potential emerging trends and patterns indicative of compromise to capture potentially emerging fraud issues sooner (e.g. prior to depletion of accounts) and more accurately. In at least some aspects, the prediction engine 100 is configured to assign a model score to depict risk of compromise to each transaction device (e.g. credit/debit/ATM card or other device compromises) or transaction or feature examined for the transaction. The risk score depicts a risk of the transaction device (e.g. a merchant devices, consumer devices, credit cards, debit cards, etc.) being compromised and potential for fraud in the immediate future so that an appropriate action may be determined by the prediction engine 100 to target different levels of risk.

The prediction engine 100 further comprises data stores or repositories for storing historical data 101 and active data 102 (e.g. transaction device and/or account data). In some aspects, the generated risk score 105, and device compromise prediction 107 may be stored in corresponding data stores or repositories of the prediction engine 100 (not shown for simplicity of illustration). The historical data 101 and active data 102 may be received from one or more computing device(s) across a communication network (e.g. a customer device of a computing device of an entity in a networked computer system for the entity, not shown) or at least partially input by a user at a computing device for the prediction engine 100 (e.g. a computing device 200 shown at FIG. 2). For example, as shown in FIG. 1B, the historical data 101 and/or the active data 102 may be derived from transactional data sources 131 and/or enterprise data warehouse 133 and extracted or derived from associated devices involved in the transactions for which prediction is occurring (e.g. merchant engine 125, transaction device 127, transaction processing servers 129, enterprise applications and systems 128).

The prediction engine 100 may include additional computing modules or data stores in various embodiments, some example components further depicted in FIG. 1B. The prediction engine 100 is configured for receiving transaction and device data including account data in historical data 101 (e.g. previous account activities, previous account properties, previous device properties, previous compromises associated with the transaction device or similar transaction devices and known account compromises) and active account data 102 (e.g. current account activities and current account properties); extracting relevant features of the data via the data extraction module 103; determining a risk score 105 associated with the risk of account compromise via an associated computing device implementing the prediction engine 100 (e.g. computing device 200) using a machine-learning based risk module 104; and predicting the likelihood of account compromise (e.g. compromise prediction 107) via a machine-learning based compromise prediction module 106. The risk module 104 generates a risk score 105 (e.g. categorized as high risk, medium risk or low risk) for the likely risk of transaction device compromise (e.g. an account access method such as a credit card or a merchant computing device is at risk of initiating fraudulent transaction requests or financial transactions), having been trained on historical data 101, based on active data 102. Compromise prediction module 106 generates a transaction device (e.g. credit card or digital wallet, etc.) compromise prediction 107 (e.g. the account and/or an account access method such as a credit card is predicted to be compromised by a fraud, and may initiate fraudulent transaction requests or other transactions in a future time period).

As shown in FIGS. 1A and 1B, input data sources for the prediction engine 100 may include a variety of computing devices and data stores including transactional data sources 131 and enterprise data warehouse 133 communicating with one or more computing devices performing, processing transaction such as merchant engine(s) 125, transaction devices 127, transaction processing server 129, and enterprise applications and systems 128. The inputs provided to the prediction engine 100 may be categorized into historical data 101 (e.g. transaction device and/or account data including previous account activities such as account debits and credits; frequency of account use; last account transaction; account properties such as associated credit limits, account address, account opening date; previous account compromise events; previous fraudulent transaction requests; device properties and previous device compromise events and patterns) and active data 102.

Referring to FIGS. 1A, 1B and 2, the data extraction module 103 is configured to automatically extract key features 141 from the input data (e.g. historical account data 101; active account data 102). Such key features 141 may be defined based on prior iterations of the prediction engine 100 and the machine learning models as being key contributors (e.g. based on high correlation values) to accurately determine risk scores and accurately predict transaction device/account compromise. That is, the machine learning models in the prediction engine 100 may be configured to determine based on prior runs of the models, the most relevant device and data attributes to extract from the input data. Additional data received/extracted/processed by the prediction engine 100 may include transactional data sources 131 which includes fraud analytics database data such as CFAD (e.g. Canadian Fraud analytics database) data including: transaction details for both genuine and fraud transactions; and user account information. Additionally, the prediction engine 100 may receive/extract/process data from enterprise data warehouse 133 (e.g. EDW) which includes period account transactions, records of identities/roles account holder/user has for that entity processing the transactions (e.g. transaction processing server 129), and transaction device information (e.g. credit card/debit card/electronic wallet, etc. information).

Such key features 141 extracted from the input data may include but are not limited to: geo-data associated with geographical information for a transaction device such as registered account address; device/account property data; and device/account transaction data. The geo-data may include but not limited to: geographical information for where a transaction device/account is registered to; where account access requests originate from (e.g. the geographical location of where an account access method or device such as a credit card or debit card/ATM card or electronic wallet initiates a transaction request; the date of received requests to change an address associated with an account). The account property data may include but not limited to: the date an account was opened; one or more credit limits or lines of credit associated with an account; the number of account access methods (e.g. credit cards) associated with an account; the date an account access method security feature (e.g. a password or personal identification number) was last changed; the expiration date associated with one or more account access methods (e.g. a credit card expiry date); previous account/device/transaction channel compromises (e.g. previous account access method compromises). The transaction data may include but not limited to: the frequency of account transaction requests (e.g. payment frequency); the nature of account transaction requests (e.g. account debits or credits); the value of account transactions; the financial balance of the account; and previous fraudulent transactions or fraudulent transaction requests associated with an account or device.

Once key features 141 are extracted from the input data, the associated data values and metadata for the extracted features may be input into the risk module 104. The risk module 104, having been trained on historical data 101 (e.g. prior compromises etc. in a past duration time window—see example training data assignment in FIG. 3, determines, based on data values and metadata of key features extracted from active data 102, the risk of account/device (e.g. credit card) compromise. The risk module 104 may be prompted to output risk score 105 on the associated computing device 200 (e.g. via a user interaction with computing device 200). The risk score 105 may be output to a graphical user interface on a computer system in communication with prediction engine 100 (e.g. output the risk score 105 to the graphical user interface of a computer associated with a user such as the computing device 200). The risk score 105 may further be input into the compromise prediction module 106.

The compromise prediction module 106, having been trained on historical account data 101, may be configured to predict, based on data values and metadata of key features extracted from the input data, e.g. active data 102 and risk score 105, and detect a likelihood of future compromise for the transaction device (e.g. credit card) in a future time period such as to pre-emptively detect potential emerging fraud and to prevent future occurrence of fraud (e.g. prior to security data breach and if applicable, financial depletion). The prediction engine 100 is thus configured, in at least some embodiments, to perform forecasting and assessment prior of compromise prior to fraudulent transaction(s) occurring (e.g. to proactively detect a potential likelihood of compromise in a future time period). This may occur by assessing a variety of factors and features such as overall activity of customers at risk of being compromised.

The compromise prediction module 106 may be prompted to output a device/account compromise prediction 107 based on the occurrence of a previous action (e.g. user interaction with computing device 200; a received request to change the address associated with an account).

Referring to FIG. 1B a more detailed schematic of the prediction engine 100 and communication with example computing devices, data servers and databases for proactively and pre-emptively forecasting transaction devices, associated accounts or other types of payment instruments (e.g. compromised credit cards, debit cards, RFID, token, etc.) having a likelihood of being compromised. In one example use, the prediction engine 100 predicts probability of future fraud for all the accounts or payment instruments that had a transaction in a defined past time period (e.g. last week. A unique identifier may be assigned to an account ID/transaction device ID and a base population for that time period. A target window of a future defined time period (e.g. 3 months) may be assigned after another selected time period of buffer. So in one exemplary use, the prediction engine 100 may forecast whether each account will have a future fraud within the future defined time period.

Thus, the data extractor 108 may be configured to retrieve different types of data from the input data sources, e.g. enterprise data 109 and transaction data 111 (e.g. transaction device information and metadata including fraud analytics). The data extractor 108 may be configured to perform such retrieval upon receiving indication of new transactions or other triggers requiring the training of the model or updating of the model. The enterprise data 109 may include: account information, account transactions, customer profiles, account summary, credit card account information, transactions for credit cards, etc. The transaction data 111 may include credit card transactions that include both fraud and genuine transactions, credit card or other payment instrument fraud transactions, snapshot of accounts and payment instrument information.

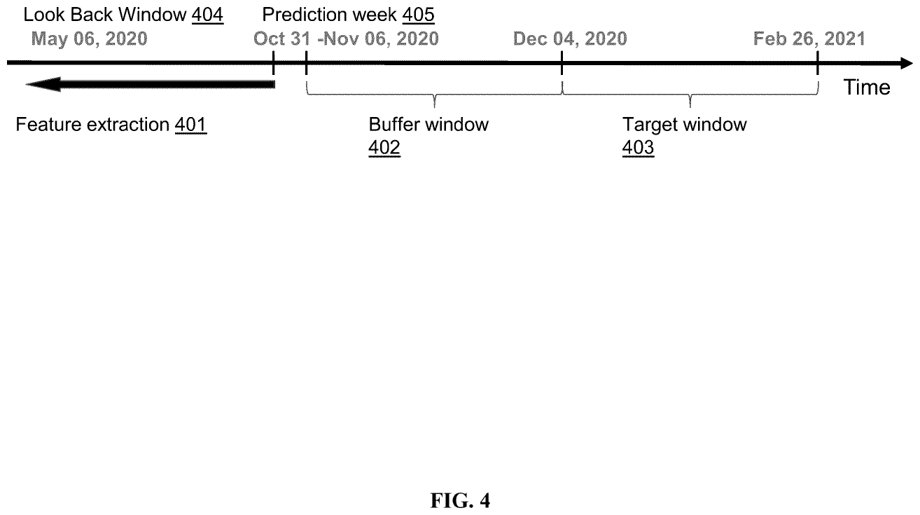

In one example implementation, the data extractor 108 may be configured to extract data spanning from beginning of the feature extraction period (e.g. see feature extraction 401 in FIG. 4 or in-time 306 in FIG. 3) to the last day of out-of-time validation split (e.g. see out-of-time 307 in FIG. 3). The data extractor 108 may be configured to create a base table containing the base population including as all accounts having a transaction in a current time period for which prediction is performed. Thus, the data extractor 108 may be configured to assign, for every account or record that has a transaction in the given time period, aggregate all transactions and label them or assign a flag of 1 where any occurrence of fraud transactions has occurred and 0 where no fraud transactions have occurred. This information generates the base table to construct the ground truth. The ground truth may define fraud in an account. Thus, the ground truth for an account or record in a week is constructed by aggregating the base table flags from the target window (e.g. target window 403), occurring after the buffer window (e.g. buffer window 402). For each account in a particular week, if there appears a fraud flag in the base table in the target window, then a target of 1 (fraud) is assigned to that account for that particular week. The target window may be defined as a time window within which the likelihood of fraud in accounts/transaction devices for the accounts is predicted.

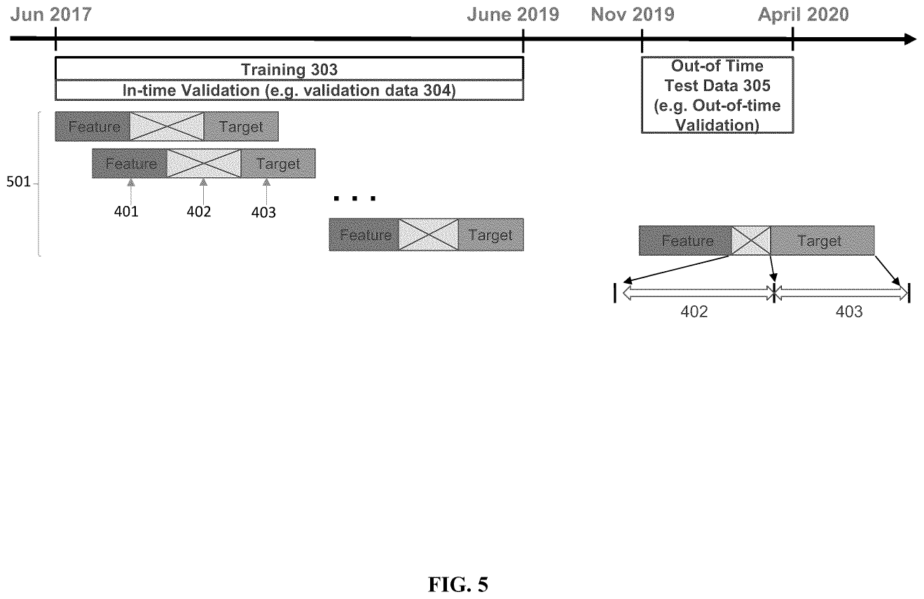

The accounts or transaction records associated with a transaction device in each defined time duration (e.g. one week) are split into training (e.g. in-sample 301 forming the training data 303 or the training samples 115) and out of Sample validation (e.g. forming the validation samples 117 or the out-of-sample 302 validation data 304). Thus there is at least one training sample set and two validation sets (one in-sample and in-time) and another out of time (or hold out validation set). Such a training, testing using both in-time and out of time validation process is also depicted in FIG. 5.

Thus, the data splitter 113 is configured to create these training and validation splits or partitions of the data (e.g. training samples 115 and validation samples 117). These splits are then used to construct the values and data for feature extraction via the feature extractor 119.

A data splitter 113 may then be configured to split the input data extracted into training samples 115 and validation samples 117 for generating the machine learning model for predicting compromise. An example of a data split performed by the data splitter 113 is illustrated in FIG. 3. In the example of FIG. 3, the training time is shown as the in-time 306 period (e.g. June 2017 June 2019). Out of time validation or testing is shown as the out-of time 307 period (e.g. October 2019-April 2020). A defined window of time (e.g. buffer window 402 shown in FIG. 4) is considered between the training and the out-of-time validation splits. Also, a window size varying size (e.g. different time windows) is used to extract features (i.e., trend features, transactions, etc.). Moreover, the engine 100 may be configured via the data splitter 113 to split the data in a given manner—e.g. an 80-20 split such that the training period accounts are separated from the training split (e.g. training samples 115) to form an out-of-sample validation split (e.g. validation samples 117). Preferably, the data splitter 113 is configured to split the data further based on each customer, or alternatively, per transaction device (e.g. for each credit card, RFID, token, etc.) basis such as to limit data leakage between the training and validation data sets and improve model performance. In FIG. 3, the in-sample 301 training data 303 is shown in the in-time 306 period and the out-of sample 302 having corresponding out-of-sample validation data 304 is also shown in the in-time 306 period. The out-of-sample validation split (e.g. validation data 304) allows the engine 100, via the model generator 121 to analyze the model (e.g. trained model 123) performance on the accounts/transaction data never seen before. Conveniently, the out-of-sample validation split (e.g. validation data 304) may be used for feature ablation, and performing seasonality analysis for the generated model (e.g. trained model 123). An out-of-time 307 time period is used by the engine 100 to assign out of time test data 305 to evaluate the performance of the generated model (e.g. trained model 123). FIG. 4 illustrates the splits across the time and the account/transaction ID dimensions.

The feature extractor 119 may be configured to extract a plurality of features 141 from the input data including but not limited to transaction features 147 (e.g. card transaction features aggregated over a time), transaction device features 149 (e.g. payment instrument characteristics such as card characteristics including limits, scores, balances, types, etc.), recency features 145 (e.g. time since last activity/changes on transaction devices), information from merchants to payment instruments/transaction devices (e.g. merchant features 143 over transactions which includes merchant metadata such as number of fraud transactions, types of merchants, etc.). In some aspects, the features 141 further include enterprise features 151 (e.g. credit card features, aggregation of customer features for the credit card accounts).

Thus, by applying these features 141 (and via the training samples 115 and corresponding validation samples 117), a model is generated via the model generator 121 to generate a trained machine learning model 123. Conveniently, in at least some aspects, the model 123 facilitates and enhances proactive compromise detection of payment instruments or transaction devices (e.g. credit cards) such as to further define actions upon detection of a potential compromise. That is, as described earlier, the engine 100 may be configured to be run on a periodic basis and transaction data grouped together based on transaction device is gathered for the time period and then scored by the generated trained model 123 to determine level of risk, e.g. potential card compromise.

For example, the prediction engine 100 may utilize transaction data relating to base population for a given time period and calculate the probability of each account or transaction device being defrauded in the future time period (e.g. including buffer and target window). Based on the determined score, the prediction engine 100 may generate a prediction 107 (e.g. which may be communicated back to one or more input devices such as merchant engines 125, transaction devices 127, transaction processing servers 129, enterprise applications and systems 128) for further action. For example, the prediction engine 100 may be configured to perform an action such as selecting compromised transaction devices, e.g. deactivating the operation of such compromised devices or deactivating transaction requests from such compromised devices (or requesting reissue thereof). Additionally, in at least some aspects, once the prediction 107 identifies the potentially fraud susceptible transaction devices (e.g. credit cards, RFID, tokens, etc.), these compromised devices are filtered out in successive weeks from the base population for generating subsequent iterations of the trained model 123. Thus once the trained model 123 is deployed in production, a transaction device that has been flagged as susceptible to fraud and an action taken thereon (e.g. reissued), would be removed from the records examined by the model generator 121 and the model 123, such that it no longer appears in the data records in the successive time windows from which the training samples 115 and/or the validation samples 117 are devised for subsequent iterations of the model. Thus, this makes the task of prediction harder for the model 123 such that in the initial runs of the model (e.g. initial weeks), the model 123 can easily catch the potentially compromised cases. After that, it becomes progressively harder for the trained model 123 but eventually a stable precision state is achieved and observed from the results. Thus, this approach causes the trained model 123 to become even more accurate over time in its predictions.

In at least some aspects, the model generator 121 applies the extracted features to train, test, validate and generate a compromise prediction model, e.g. the trained model 123 being a machine learning model. The trained model 123 (also see risk module 104 and compromise prediction module 106) is preferably an extreme gradient boosted model, or XGBoost or other tree-based gradient boosting model. An example generated XGBoost model is shown at XGBoost model 123′ in FIG. 1B. The XGBoost model conveniently may handle large datasets useful for training and validation and can handle a diverse range of input features including numerical and categorical feature types.

Preferably, the model generator 121 uses the XGBoost algorithm. The trained model 123 utilizes decision trees for classifying tabular data into groups. At each node of the tree, instances are split into subtrees based on the value of one feature being above or below a threshold. Different nodes can use different features for their splits. Leaf nodes appear at the bottom of the tree and assign a score to all instances which end at that leaf. In one aspect, the trained model 123 utilizes XGBoost which is a boosted tree classifier. The model 123 when implemented by XGBoost is an ensemble of many individual decision trees, where subsequent trees are trained to correct the mistakes of previous trees. The model 123 when implementing XGBoost uses gradient descent on a loss function to determine the optimal feature and threshold to use for every split. Conveniently, in at least some aspects, the trained model 123 is configured via XGBoost to handle a diverse range of input features including numerical and categorical feature types.

Referring to FIG. 1B, the prediction engine 100 may retrieve transactions and associated metadata (e.g. by accessing one or more associated data servers, databases and computing devices) via the data extractor 108 from a variety of data sources, including the transactional data sources 131 and/or enterprise data warehouse 133 communicating with a number of computing devices and databases including but not limited to merchant engines 125, transaction devices 127, transaction processing servers 129, and enterprise applications and systems 128. The transactional data sources 131 may include fraud analytics data such as but not limited to: transaction details both for genuine and fraud; fraud transaction details; user account information. The enterprise data warehouse 133 may include transaction device information such as but not limited to: period account transactions; record of roles a customer or user has with a particular payment instrument accounts; and a particular payment instrument or transaction device card information.

FIG. 4 illustrates an example timeline and scenario for the separation as well as assignment of data by the prediction engine 100 for formulating the training samples 115 and/or validation samples 117 and generating the model (e.g. trained model 123). As shown in the example embodiment of FIG. 4, if the prediction time period when the engine 100 is run, e.g. the prediction week 405, then a subsequent later defined time period is defined as the buffer window 402 and a further subsequent time period is defined as a target window 403.

Referring to FIGS. 1A, 1B, 2, 3 and 4, for training the machine learning prediction model and generating the trained model 123, the engine 100 constructs training instances (e.g. training samples 115), and ground truth as shown in the example steps as indicated in FIG. 4. Consider a sample prediction week 405. Then, all the accounts or transaction devices or payment instruments (as provided in the data retrieved via the data extractor 108) that had a transaction in that week form the base population. For all these accounts or transaction devices, features are then extracted from a look back window (e.g. via the feature extractor 119 in FIG. 1B)—shown as feature extraction 401. In at least some aspects, the feature extractor 119 may be configured to automatically extract features based on obtaining feature importance plot and correlating to prediction 107 for prior runs of the model such that outliers are removed and only those features having a high degree of correlation to the prediction are utilized. The example look back window 404 ranges from last 24 weeks to last week for different feature tables. In order to calculate the target, the engine 100 first leaves out a buffer window 402 (e.g. 4 weeks). After this buffer window 402, a subsequent window of time, e.g. next 12 weeks, are defined as the target window 403. Thus, if the transaction devices/associated accounts in the base population have any fraud in this target window 403, then the prediction engine 100 assigns these accounts or data records a training label of 1 (e.g. fraud). With the targets defined in this way, FIG. 5 illustrates snapshots for the entire duration of training and validation (e.g. training samples 115 and validation samples 117) in the same way as show in FIG. 5. As can be seen from FIGS. 4 and 5, the engine 100 constructs such snapshots for each given duration of time in a sliding window fashion. The engine 100 is configured to leave out a buffer of time window (e.g. June-November 2019) after which the out of time validation period starts (e.g. formulating the validation samples 117).

Referring to FIG. 5, the rolling or sliding window 501 of training and validation is shown over time (including preferably a buffer window between the feature training and the target window). There is also shown in FIG. 5, the in-time validation or validation data 304 and the out-of time validation or out-of time test data 305. As shown in FIGS. 3 and 5, the in-time validation sample sets part of the total sample set (e.g. the in-time 306 sample set) available for developing and generating the model. As noted earlier, the total sample set may be either randomly split or otherwise defined such that one portion is used for development and another portion for validation.

Thus, the model generator 121 may be configured to use the training or development sample portion, e.g. the training data 303 shown in FIGS. 3 and 5 to generate an iteration of the model (e.g. the trained model 123). Subsequently, the generated model is applied to the holdout or out-of-sample 302 validation data 304 to perform in-time validation and determine the generated model's predictive accuracy based on the validation data that is different than the training samples and not used to initially generate the model. Subsequently and additionally, the out-of time validation or test data 305 shown in FIGS. 3 and 5 which contains data samples from a different time period (e.g. out of time) than that which was originally used for generating the model originally is used to validate the generated model further and to further evaluate the accuracy and robustness of the model. The out-of time test data 305 (also referred to as the holdout data) may be used to provide a further estimate of the machine learning model's performance subsequent to training and validation.

Conveniently, in at least some aspects, the combination and partitioning of training, testing and validation using the in-time partitions for the training and validation sets (respectively assigned to in-sample and out of sample) and out of time partitions for the validation sets as described herein and shown in FIGS. 3-5 allows developing a robust and accurately generated trained model 123 that is relevant to predicting data that is collected in the future (e.g. unseen data) and not only data which the model has been previously trained on. Thus, in at least some aspects the prediction engine 100 automatically partitions and assigns training, testing, validation and buffer data sets from the available pool of transaction data (e.g. having features 141 including but not limited to: merchant features 143, recency features 145, transaction features 147, transaction device features 149 and enterprise features 151 and other identified features of relevance) to generate accurate machine learning models for predicting a future likelihood of compromise or fraud, e.g. the trained model 123 or extreme gradient boosted model 123′.

Preferably and referring to FIGS. 3 and 5, the split between training data 303 and the validation data 304 is done based on accounts or transaction devices. While the split between the training data 303/validation data 304 and the testing data 305 is done across time. For example, the separation between the training data 303 and the validation data 304 in the in-time period may be done based on account IDs/transaction device IDs so that if an account ID/transaction device ID associated with one or more transaction data or feature data is assigned to one group, then other transaction information for that account ID/transaction ID is assigned to the same group. Thus, the splits across time and account IDs/transaction device IDs for separating and assigning the training data 303, the validation data 304, the out of time test data 305 generates, in at least some aspects, a more robust and accurate machine learning model generated by the model generator 121 (e.g. the trained model 123) for performing compromise predictions. Notably, in some aspects, the data splitter 113 shown in FIG. 1B may be configured to perform the data splits across the time and account or device ID dimensions.

Conveniently, in at least some aspects, specifically splitting the transaction data for a first time period into training samples 115 and validation samples 117 for generating the machine learning model (in-time 306) and assigning out of time 307 transaction data to testing data samples (e.g. out of time test data 305) for testing the model, once generated, using a buffer window of time between the in-time and out-of time data (e.g. between the training/validation data set provided in-time and the testing data set provided out of time) in this manner and process prevents leakage issues and addresses feature ablation and in doing so allows the model to generate more accurate prediction results when dealing with unseen data. Feature ablation is used to determine feature importance by removing parts of the data and testing its performance. Further conveniently, in at least some aspects, the sliding window technique applied by applying a rolling subset window of time (e.g. one week) for feature extraction (training), buffer window and target (e.g. testing) which is rolled through the in-time training/testing window of time having observed transaction data further improves the accuracy for the predictions from the generated prediction machine learning model (e.g. trained model 123).

FIG. 2 illustrates example computer components of an example computing device, such as a computing device 200 for providing the prediction engine 100 described with respect to FIGS. 1A and 1B, in accordance with one or more aspects of the present disclosure.

The computing device 200 comprises one or more processors 201, one or more input devices 202, one or more communication units 205, one or more output devices 204 (e.g. providing one or more graphical user interfaces on a screen of the computing device 200) and a memory 203. Computing device 200 also includes one or more storage devices 207 storing one or more computer modules such as the prediction engine 100, a control module 208 for orchestrating and controlling communication between various modules (e.g. data extraction module 103, risk module 104, compromise prediction module 106, trained model 123 and the modules shown in FIGS. 1A and 1B) and data stores of the prediction engine 100, historical transaction/account data 101 and active transaction/account data 102. The computing device 200 may comprise additional computing modules or data stores in various embodiments (e.g. as shown in FIGS. 1A and 1B). Additional computing modules and devices that may be included in various embodiments, are not shown in FIG. 2 to avoid undue complexity of the description, such as communication with one or more other computing devices, as applicable, for obtaining the historical data 101 and/or the active data 102 including via a communication network, not shown.

Communication channels 206 may couple each of the components including processor(s) 201, input device(s) 202, communication unit(s) 205, output device(s) 204, memory 203, storage device(s) 207, and the modules stored therein for inter-component communications, whether communicatively, physically and/or operatively. In some examples, communication channels 206 may include a system bus, a network connection, an inter-process communication data structure, or any other method for communicating data.

One or more processors 201 may implement functionality and/or execute instructions within the computing device 200. For example, processor(s) 201 may be configured to receive instructions and/or data from storage device(s) 207 to execute the functionality of the modules shown in FIG. 2, among others (e.g. operating system, applications, etc.). Computing device 200 may store data/information (e.g. historical account data 101; active account data 102; previous compromise predictions (e.g. account compromise prediction 107) to storage device(s) 207.

One or more communication units 205 may communicate with external computing devices via one or more networks by transmitting and/or receiving network signals on the one or more networks. The communication units 205 may include various antennae and/or network interface cards, etc. for wireless and/or wired communications.

Input devices 202 and output devices 204 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 206).

The one or more storage devices 207 may store instructions and/or data for processing during operation of the computing device 200. The one or more storage devices 207 may take different forms and/or configurations, for example, as short-term memory or long-term memory. Storage device(s) 207 may be configured for short-term storage of information as volatile memory, which does not retain stored contents when power is removed. Volatile memory examples include random access memory (RAM), dynamic random access memory (DRAM), static random access memory (SRAM), etc. Storage device(s) 207, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable read-only memory (EPROM) or electrically erasable and programmable read-only memory (EEPROM).

The computing device 200 may include additional computing modules or data stores in various embodiments. Additional modules, data stores and devices that may be included in various embodiments may not be shown in FIG. 2 to avoid undue complexity of the description. Other examples of computing device 200 may be a tablet computer, a person digital assistant (PDA), a laptop computer, a tabletop computer, a portable media player, an e-book reader, a watch, a customer device, a user device, or another type of computing device.

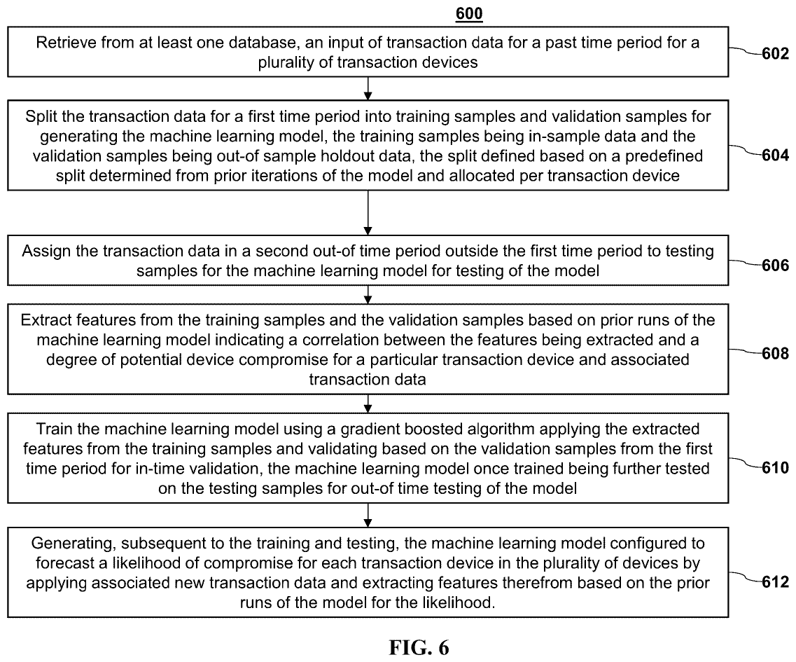

Referring to FIG. 6 shown is an example flow of operations 600 illustrating a method for the computing device 200 of FIG. 2 implementing the prediction engine 100 of FIG. 1A or FIG. 1B for predicting a likelihood of future compromise (e.g. emerging compromise) in one or more transaction devices, in a future time period, proactively in a networked system of computers communicating transactions therebetween.

At step 602, a trigger may be received to initiate the data extractor 108 to retrieve transaction data and other metadata for triggering the prediction engine 100 to automatically generate a prediction model for forecasting compromised transaction devices and/or transaction. The trigger may include an indication of new transaction data for a particular payment instrument during a time period of interest, indication of a need to update the training model 123 (e.g. prediction model performance degrading) or other indication of new events or behaviours detected in associated computing systems of interest—e.g. merchant engines 125, transaction devices 127, transaction processing servers 129, and enterprise applications and systems 128. Thus at step 602, operations configure the computing device 200 to retrieve from at least one database, an input of transaction data for a past time period for a plurality of transaction devices. For example, different transaction data sets may be gathered by the prediction engine 100 corresponding to associated transaction devices in a defined range of time to train, test and validate a machine learning prediction model, e.g. the trained model 123 for compromise prediction 107.

Generally and as noted earlier, the computing device 200 comprises a prediction engine 100 which is configured to utilize a trained model 123 for early detection of one or more computing transaction devices (e.g. credit card, RFID, token, digital wallet, wireless device, payment instruments etc.) which are at risk of compromise. In at least some embodiments, each transaction device examined by the prediction engine 100 is assigned a model score to depict the risk of the transaction device being compromised and potential for fraud in the immediate future time period so that different strategies and actions may be implemented by the computing device 200 to target different levels of risk.

Following operation step 602, at step 604, the computing device 200 is configured to split the transaction data as retrieved in a first time period (e.g. the in-time period shown in FIGS. 3 and 5), into training samples (e.g. training data 303) and validation samples (e.g. validation data 304) for generating the machine learning model, the training samples being in-sample data and the validation samples being out-of sample or holdout data. Generally, as will be described, the training data set is selected in-sample (data which is known or observed) and used for the initial estimation and model generation of the trained model 123 whereby the out-of sample data (or unseen data) is used to check the accuracy of the model. In at least some aspects, the split defined between the training and testing data sets is based on a predefined split determined from prior iterations of the model (e.g. which split provided an accurate prediction) and may be further allocated per transaction device or per account basis. Preferably, in at least some aspects, the split between the training and validation data may occur based on transaction device identifiers or account identifiers or based on a customer identifier basis for each transaction. In this aspect, there's no overlap across customers or across different transaction devices for the training data and the validation data (e.g. all transactions identified for a particular customer may be grouped in either the training data or the validation data but not both so there's no overlap in customer data). In this aspect, the split may occur per customer or per unique transaction device such as to improve the efficiency of the prediction model. Thus, this may allow training the model 123 on one set of accounts, and validating the model on a different set of accounts such as to improve model performance. In one aspect and as described in FIG. 5, the split may further occur on a rolling window basis such that by including a buffer window and a prediction window of time, the model 123 excludes prior predictions when tested in performance such as to further improve the model performance.

Following operation step 604, at operation step 606, the computing device 200 is configured to assign the transaction data in a second out-of time period (e.g. see out-of time 307 window in FIG. 3) outside the first time period (e.g. in-time 306) to testing samples for the machine learning model for testing of the model subsequent to the training and validation of the trained model 123.

Thus, in at least some implementations, the trained model 123 may be generated by one training set, and two validation data sets, including out of time validation (e.g. no overlap with training data) and out of sample validation (e.g. overlap in time but no overlap in customers/transaction devices) to improve accuracy of the model in performing predictions.

Following operation step 606, at operation step 608, the computing device 200 is configured to extract one or more relevant features (e.g. features 141) from the training samples and the validation samples based on prior runs of the machine learning model, e.g. trained model 123, indicating a correlation between the relevant features being extracted and a degree of potential device compromise for a particular transaction device and associated transaction data (e.g. feature extraction 401 in FIGS. 4 and 5). In one implementation, the trained machine learning model 123 is a decision tree classifier and has a plurality of features retained in the trained and validated model. Such features 141 may represent in one example information relevant to the transactions and the predictions from four categories which include but are not limited to: transaction features 147, credit card or other payment instrument characteristics (transaction device features 149), recency features 145, information from merchant devices (merchant features 143) to credit cards (enterprise features 151) or other payment instrument devices.

Following operation 608, at operation 610, the computing device 200 is configured, via the model generator 121, to train the machine learning model and generate a trained model 123 using a gradient boosted algorithm applying the extracted features from the training samples and validating based on the validation samples from the first time period for in-time validation, the machine learning model once trained being further tested on the testing samples for out-of time testing of the model (e.g. out of time test data 305 or out of time validation). For example, the trained and validated model may first be tested on latest unseen data and its performance rated to determine whether hyperparameters or other tuning of the trained model 123 should occur to adjust the accuracy of the model. As shown in the example of FIG. 5, out of time test data 305, e.g. data from November 2019-April 2020 is used to evaluate the performance of the trained model.

At operation 612, following operation 610, the computing device 200 is configured to generate subsequent to the training, testing and validation of the model an updated iteration of the machine learning model (e.g. the trained model 123) for forecasting based on the transaction data and the features extracted, a likelihood of compromise for each of the transaction devices in a future time period. This may occur by applying the new or recently received transaction data (e.g. during a prediction week timeline) for a particular transaction device and extracting features (e.g. features 141) therefrom to determine patterns and identify emerging trends as to whether the features as extracted (and their corresponding feature values for the particular transaction device) and as a whole indicate a likelihood higher than a pre-defined threshold of compromise in the future, such a likelihood may be provided as a compromise prediction 107. That is, in at least some embodiments, the trained model 123 is configured to process new transaction data for a particular transaction device (and associated devices) and generate a future risk score for the particular transaction device (e.g. based on the features retrieved within the new transaction data, patterns determined from the extracted features and the feature data where the relevant features are predetermined by the machine learning model 123 based on prior training, testing and validation runs of the model). As shown, in at least some aspects, there's at least some gap of time between the prediction week 405 shown in FIG. 4, followed by a buffer window 402 until the target window 403 such that a future likelihood of compromise is detected by the model 123.

The prediction engine 100 may provide the risk score (e.g. as determined by the risk module 104) to the compromise prediction module 106 which is configured to make a decision as to whether a further action should be triggered for implementation (e.g. reissuing a credit card or disabling a transaction device from operation). The compromise prediction module 106 may be configured to generate the decision regarding the action to be taken by the computing device 200 (and in some cases in communication with associated computing devices for the transaction device being examined) in an automated form based on the score cut-off and a limit of transaction cards to allow to be marked as compromised (e.g. as predetermined by the computing device 200). For example, the compromise prediction module 106 may be further configured to display the compromise prediction 107 on a user interface associated therewith (e.g. output device 204) for confirmation thereof. For example, if an input is received on the user interface confirming the prediction of fraud, the computing device 200, may in some implementations be configured to trigger the reissuance of the transaction device marked as compromised and prevent further transactions or requests therefrom.

One or more currently preferred embodiments have been described by way of example. It will be apparent to persons skilled in the art that a number of variations and modifications can be made without departing from the scope of the invention as defined in the claims.

What is claimed is:

1. A computer system for automatically generating a machine learning model for forecasting a likelihood of compromise in one or more transaction devices, the computer system comprising:
a processor configured to execute instructions;
a non-transient computer-readable medium comprising instructions that when executed by the processor cause the processor to:
retrieve from at least one database, an input of transaction data for a past time period for a plurality of transaction devices;
split the transaction data for a first time period into training samples and validation samples for generating the machine learning model, the training samples being in-sample data and the validation samples being out-of sample holdout data, the split defined based on a predefined split determined from prior iterations of the model and allocated per transaction device;
assign the transaction data in a second out-of time period outside the first time period to testing samples for the machine learning model for testing of the model;
extract features from the training samples and the validation samples based on prior runs of the machine learning model indicating a correlation between the features being extracted and a degree of potential device compromise for a particular transaction device and associated transaction data;
train the machine learning model using a gradient boosted algorithm applying the extracted features from the training samples and validating based on the validation samples from the first time period for in-time validation, the machine learning model once trained being further tested on the testing samples for out-of time testing of the model; and,
generate, subsequent to the training and testing, the machine learning model configured to forecast a likelihood of compromise for each transaction device in the plurality of devices by applying associated new transaction data and extracting features therefrom based on the prior runs of the model for the likelihood.

2. The system of claim 1, wherein the machine learning model is generated with at least one training sample set and two validation sample sets, one validation set relating to out of time validation and another validation set relating to out of sample validation.

3. The system of claim 1, wherein the second out-of time period occurs after the first time period and separated by a buffer window, the buffer window separating a window of time for feature extraction and a target window for testing the machine learning model.

4. The system of claim 3, wherein the machine learning model is an extreme gradient boosted model.

5. The system of claim 4, wherein the system is further configured to instruct one or more computing devices associated with the compromised transaction device to perform one or more actions based upon the likelihood of compromise detected for each transaction device.

6. The system of claim 3, wherein the window of time for feature extraction varies depending upon a type of feature being extracted thereby different features having associated different window sizes for the model to perform feature extraction.

7. The system of claim 3, wherein during the first time period, feature extraction and target evaluation are respectively associated with the training samples and the testing samples and performed in a sliding window format having a defined time period.

8. The system of claim 7, being further configured to remove from consideration in training subsequent iterations of the machine learning model, transactions being associated with susceptible compromised transaction devices determined from prior runs of the machine learning model indicating a positive likelihood of compromise.

9. The system of claim 1, wherein the extracted features are selected from: enterprise data features, and fraud analytics features for the plurality of transaction devices, the enterprise data features having transaction device information and associated records for each transaction device; and the fraud analytics features selected from: transaction features, transaction device characteristics, recency features and merchant device features.

10. The system of claim 1, wherein splitting the transaction data into training and validation samples is performed during a same time period across transaction device identifiers or transaction record identifiers such that transaction data having similar transaction device identifiers or transaction record identifiers are grouped together within one of the training and validation samples.

11. A computer implemented method for automatically generating a machine learning model for forecasting a likelihood of compromise in one or more transaction devices, the method comprising:
retrieving from at least one database, an input of transaction data for a past time period for a plurality of transaction devices;
splitting the transaction data for a first time period into training samples and validation samples for generating the machine learning model, the training samples being in-sample data and the validation samples being out-of sample holdout data, the splitting defined based on a predefined split determined from prior iterations of the model and allocated per transaction device;
assigning the transaction data in a second out-of time period outside the first time period to testing samples for the machine learning model for testing of the model;
extracting features from the training samples and the validation samples based on prior runs of the machine learning model indicating a correlation between the features being extracted and a degree of potential device compromise for a particular transaction device and associated transaction data;
training the machine learning model using a gradient boosted algorithm applying the extracted features from the training samples and validating based on the validation samples from the first time period for in-time validation, the machine learning model once trained being further tested on the testing samples for out-of time testing of the model; and
generating, subsequent to the training and testing, the machine learning model configured to forecast a likelihood of compromise for each transaction device in the plurality of devices by applying associated new transaction data and extracting features therefrom based on the prior runs of the model for the likelihood.

12. The method of claim 11, wherein the machine learning model is generated with at least one training sample set and two validation sample sets, one validation set relating to out of time validation and another validation set relating to out of sample validation.

13. The method of claim 11, wherein the second out-of time period occurs after the first time period being in-time and separated by a buffer window, the buffer window separating a window of time for feature extraction and a target window for testing the machine learning model.

14. The method of claim 13, wherein the machine learning model is an extreme gradient boosted model.

15. The method of claim 14, wherein the method is further configured to instruct one or more computing devices associated with the compromised transaction device to perform one or more actions based upon the likelihood of compromise detected for each transaction device.

16. The method of claim 13, wherein the window of time for feature extraction varies depending upon a type of feature being extracted thereby different features having associated different window sizes for the model to perform feature extraction.

17. The method of claim 13, wherein during the first time period, feature extraction and target evaluation are respectively associated with the training samples and the testing samples and performed in a sliding window format having a defined time period.

18. The method of claim 17, being further configured to remove from consideration in training subsequent iterations of the machine learning model, transactions being associated with susceptible compromised transaction devices determined from prior runs of the machine learning model indicating a positive likelihood of compromise.

19. The method of claim 11, wherein the extracted features are selected from: enterprise data features, and fraud analytics features for the plurality of transaction devices, the enterprise data features having transaction device information and associated records for each transaction device; and the fraud analytics features selected from: transaction features, transaction device characteristics, recency features and merchant device features.

20. A computer program product comprising a non-transient storage device storing instructions for automatically generating a machine learning model for forecasting a likelihood of compromise in one or more transaction devices, the instructions when executed by at least one processor of a computing device configure the computing device to perform the steps of:
retrieving from at least one database, an input of transaction data for a past time period for a plurality of transaction devices;
splitting the transaction data for a first time period into training samples and validation samples for generating the machine learning model, the training samples being in-sample data and the validation samples being out-of sample holdout data, the splitting defined based on a predefined split determined from prior iterations of the model and allocated per transaction device;
assigning the transaction data in a second out-of time period outside the first time period to testing samples for the machine learning model for testing of the model;
extracting features from the training samples and the validation samples based on prior runs of the machine learning model indicating a correlation between the features being extracted and a degree of potential device compromise for a particular transaction device and associated transaction data;
training the machine learning model using a gradient boosted algorithm applying the extracted features from the training samples and validating based on the validation samples from the first time period for in-time validation, the machine learning model once trained being further tested on the testing samples for out-of time testing of the model; and
generating, subsequent to the training and testing, the machine learning model configured to forecast a likelihood of compromise for each transaction device in the plurality of devices by applying associated new transaction data and extracting features therefrom based on the prior runs of the model for the likelihood.
